(19) United States
(12) Patent Application Publication
(10) Pub. No.: US 2025/0093492 A1
(43) Pub. Date: Mar. 20, 2025

(54) TARGET TRACKING APPARATUS AND TARGET TRACKING METHOD

(71) Applicant: Furuno Electric Co., Ltd., Nishinomiya-City (JP)

(72) Inventors: Seiichi UOSHITA, Nishinomiya city (JP); Daisuke FUJIOKA, Takarazuka city (JP)

(73) Assignee: Furuno Electric Co., Ltd., Nishinomiya-City (JP)

(21) Appl. No.: 18/882,777

(22) Filed: Sep. 12, 2024

(30) Foreign Application Priority Data
Sep. 15, 2023 (JP) 2023-149852

(51) Int. Cl. G01S 13/66; G01S 7/41

(52) U.S. Cl. CPC G01S 13/66; G01S 7/415

(57) ABSTRACT

The disclosure discloses a target tracking apparatus for tracking target on the water of the invention is provided using. An echo data acquiring interface is configured to acquire echo data indicating a correspondence relationship between a position in the detection area and the level of the reflected wave at which the electromagnetic wave transmitted through the antenna is reflected at the position. A target extracting unit is configured to extract a potential target based on the echo data. A fluctuation value calculator is configured to calculate a fluctuation value indicating the fluctuation of the potential target based on the acquired echo data of the potential target at each timing acquired the echo data. The tracking processor is configured to determine a target to be tracked based on the fluctuation value and track the target.

### CROSS-REFERENCE TO RELATED APPLICATION

This application claims priority to Japanese Patent Application No. 2023-149852 filed on Sep. 15, 2023. The entire disclosure of Japanese Patent Application No. 2023-149852 is hereby incorporated herein by reference.

### TECHNICAL FIELD

The disclosure relates to a target tracking apparatus and a target tracking method.

### BACKGROUND

Conventionally, many techniques have been developed to suppress clutter in radar equipment having a function of tracking a target based on echo data. For example, a Japanese Patent Application No. 2012-103197 describes a scanning correlation method corresponding to a moving target as follows.

The moving-target correspondence type scan correlation method includes a receiving video memory for storing video signals sequentially outputted from a signal receiver of a radar, an ultrasonic wave, and an optical camera device for each scan; a moving vector calculating section for dividing a plurality of scan images stored in the receiving video memory into a small section area and calculating a moving vector of a target existing in the area; a target fluctuation value calculator for calculating a an fluctuation value indicating the possibility of the presence of the target; a clutter level calculator for calculating a clutter level in the small area; a scan correlation processing section for using the respective outputs of the target fluctuation value calculator, the moving vector calculator, and the clutter level calculator as inputs; and a display for displaying the output of the scan correlation processor.

However, beyond the technology described in Japanese Patent Application, it is desirable to realize a technology capable of suppressing false tracking of target S in a radar apparatus.

### SUMMARY

The disclosure is made to solve the above-mentioned problems, and the target tracking apparatus, target tracking method, and target tracking program capable of suppressing false tracking of target S are provided.

To solve the above-mentioned problem, a target tracking apparatus for tracking a target on the water according to an aspect of the disclosure is an apparatus for tracking a target in a target detection area, and is provided with an echo data acquiring interface configured to periodically acquire echo data indicating a correspondence relationship between a position in the detection area and the level of the reflected wave at which the electromagnetic wave transmitted through the antenna is reflected at the position; a target extracting unit configured to extract one or a plurality of potential targets to be tracked based on the level of the echo data; a fluctuation value calculator configured to calculate each fluctuation value indicating a fluctuation of a target based on the echo data of the potential target acquired at each timing; and a tracking processor configured to determine a target to be tracked based on the fluctuation value and track the target. Here, the tracking processor is configured to select and track the potential target whose fluctuation value is less than a predetermined fluctuation threshold. On the other hand, the tracking processor may remove the potential target whose fluctuation value is equal to or greater than the fluctuation threshold.

In the target tracking apparatus according to an aspect of the disclosure, the processing circuitry may be configured to calculate the fluctuation value based on the area of the region formed by the end points when the velocity vectors share a common base point. Also, the processing circuitry may be configured to calculate the fluctuation value based on the displacement amount of the velocity vector of the potential target.

The processing circuitry may be configured to select the potential target as a target to be tracked, whose fluctuation value is less than a fluctuation threshold. The processing circuitry may be configured to select the potential target having the smallest fluctuation value as a target to be tracked.

The target tracking apparatus according to an aspect of the disclosure, the processing circuitry may be configured to determine a fluctuation threshold based on the size of the potential target and determine whether the fluctuation value is less than the fluctuation threshold or not. Here, when the fluctuation value is less than the fluctuation threshold, the processing circuitry may be configured to select the potential target as a target to be tracked. When the fluctuation value is equal to or greater than the fluctuation threshold, the processing circuitry may be configured to track the predicted position based on the position of the target already tracked as the target to be tracked.

The target tracking apparatus according to an aspect of the disclosure may further comprises a display configured to display the target tracked. Here, when the fluctuation value is equal to or greater than the fluctuation threshold, the processing circuitry may be configured to track the target by the background tracking process. Also, the display may be configured to skip to display the target by the background tracking process. The display may be configured to display the target by the background tracking process in a manner different from the tracked target by the tracking process.

The target tracking apparatus according to an aspect of the disclosure, the processing circuitry may further be configured to remove the target tracked based on a first target echo data and the target echo data acquired after the first echo data, when the fluctuation value of the target extracted based on the first target echo data is equal to or greater than the fluctuation threshold.

When the reflector is removed from the target to be tracked in the tracking processing, the target tracking apparatus may perform interpolation processing for interpolating the position of the target with the predicted position of the target. With such a configuration, even if the target to be tracked cannot be detected based on echo data generated at a certain timing, tracking of the target can be continued.

The processing circuitry may be configured to approximate the target by a polygonal reference shape and determine the fluctuation threshold based on the size of the polygonal reference shape. The processing circuitry may be configured to approximate the target by a reference shape surrounded by two lines extending in the distance direction from the antenna and two arcs extending in the azimuthal direction around the antenna and determine the fluctuation threshold based on the size of the reference shape.

The processing circuitry may be configured to calculate the size of the target based on the distance between the antenna and the target. Also, the processing circuitry may further be configured to determine the fluctuation threshold based on Automatic Identification System AIS information transmitted from another vessel.

The processing circuitry may calculate the index value based on the amount of change in the velocity vector of the reflector. With this configuration, it is possible to more appropriately determine whether or not the reflector should be a tracking object based on the amount of change in the velocity vector of the reflector.

The processing circuitry may calculate the index value based on the amount of change in the position of the reflector. With this configuration, it is possible to more appropriately determine whether or not the reflector should be a tracking object based on the amount of change in the position of the reflector. The target tracking apparatus according to an aspect of the disclosure may further comprises a memory including a computer code configured to, when executed by the processing circuitry, cause the apparatus to periodically acquire echo data indicating a correspondence relationship between a position in the detection area and the level of the reflected wave at which the electromagnetic wave transmitted through an antenna is reflected at the position; extract one or a plurality of potential targets to be tracked based on the level of the echo data; calculate each fluctuation value of the potential target based on the acquired echo data of the potential target at each timing acquired the echo data; determined a target to be tracked based on the fluctuation value; and track the target.

The target tracking method for tracking a target on the water comprises; periodically acquiring echo data indicating a correspondence relationship between a position in the detection area and the level of the reflected wave at which the electromagnetic wave transmitted through an antenna is reflected at the position; extracting one or a plurality of potential targets to be tracked based on the level of the echo data; calculating each fluctuation value of the potential target, based on the change in the velocity vector of the potential target calculated based on the position of the potential target acquired at each successive timing; determining a target to be tracked based on the fluctuation value; and tracking the target.

The non-transitory computer readable medium storing a program causing a computer to execute image process, the image process comprises: periodically acquiring echo data indicating a correspondence relationship between a position in the detection area and the level of the reflected wave at which the electromagnetic wave transmitted through an antenna is reflected at the position;
extracting one or a plurality of potential targets to be tracked based on the level of the echo data;
calculating each fluctuation value of the potential target based on the acquired echo data of the potential target acquired at each timing; determining a target to be tracked based on the fluctuation value; and tracking the target.

A target with a large fluctuation may not be a target to be detected, such as a clutter occurrence point. It is possible to determine whether or not a target should be a tracking target by determining whether or not a fluctuation value indicating fluctuation of the target is equal to or greater than a threshold. It makes possible to determine whether or not a target should be a tracking target by determining a threshold based on the size of the target. For example, the size of the target may vary depending on the beam width output from the radar equipment. By using a threshold that considers the size of the fluctuation that may still be detected, false tracking of the target may be appropriately suppressed.

A reflector having a large fluctuation may, for example, actually be a point where clutter occurs and not a target to be tracked. Therefore, it is possible to determine whether or not the reflector should be a tracking object by setting an index value indicating the fluctuation of the reflector, calculating the index value for the reflector, and determining whether or not the index value exceeds a threshold value. Further, by setting a threshold value based on the size of the reflector, it is possible to more appropriately determine whether or not the reflector should be a tracking object. By adopting such a method, it is possible to perform the above determination using a threshold value in which the magnitude of the fluctuation that can be detected in the echo data of the reflector is taken into consideration according to the size of the reflector with respect to the beam width output from the radar device. According to the disclosure, it is possible to suppress false tracking of a target in a radar apparatus.

### BRIEF DESCRIPTION OF DRAWINGS

FIG. 1 is a diagram showing a configuration of a radar equipment according to an embodiment of the disclosure.

FIG. 2 is a diagram showing an example of an echo image displayed by a tracking processor in the radar equipment according to an embodiment of the disclosure.

FIG. 3 is a diagram showing a trail of a target to be detected by the radar equipment according to an embodiment of the disclosure and a trail of a clutter generation point.

FIG. 4 is a diagram showing an example of a method for calculating a fluctuation value by the tracking processor in the radar equipment according to an embodiment of the disclosure.

FIG. 5 is a diagram showing an example of a method for calculating the fluctuation value by the tracking processor in the radar equipment according to an embodiment of the disclosure.

FIG. 6 is a diagram showing an example of a method for determining a threshold by the tracking processor in the radar equipment according to an embodiment of the disclosure.

FIG. 7 is a diagram showing an example of a detected position and a predicted position of the reflector R detected at each timing of a predetermined period.

FIG. 8 is a diagram showing an example of an echo image generated by the tracking processor in the radar apparatus according to the embodiment of the disclosure.

FIG. 9 is a diagram showing another example of an echo image generated by the tracking processor in the radar apparatus according to the embodiment of the disclosure.

FIG. 10 is a diagram showing another example of an echo image generated by the tracking processor in the radar apparatus according to the embodiment of the disclosure.

FIG. 11 is a diagram showing another example of an echo image generated by the tracking processor in the radar apparatus according to the embodiment of the disclosure.

FIG. 12 is a diagram showing another configuration of a radar equipment according to an embodiment of the disclosure.

FIG. 13 is a flowchart showing an example of an operation when a target tracking processor in the radar equipment according to an embodiment of the disclosure performs tracking processing.

### DETAILED DESCRIPTION

Hereinafter, an embodiment of the disclosure will be described with reference to the drawings. The same reference numerals are used for the same or equivalent portions in the drawings, and the description is not repeated. In addition, at least a part of the following embodiments may be optionally combined.

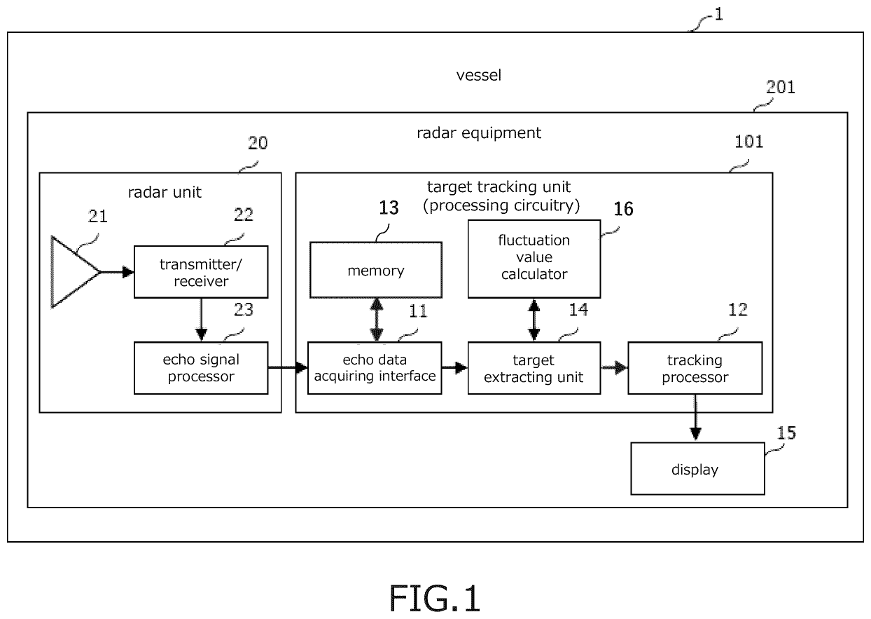

FIG. 1 is a diagram showing a configuration of a radar equipment according to an embodiment of the disclosure.

Referring to FIG. 1, a radar equipment 201 includes a radar unit 20, a target tracking unit 101 and a display 30 to display a result of a tracking target. The target tracking unit 101 is an example of a target tracking apparatus. The radar unit 20 includes an antenna 21, a transmitter/receiver 22, and an echo signal processor 23. The target tracking unit 101 includes an echo data acquiring interface 11, a tracking processor 12, a memory 13, a target extracting module 14 and a fluctuation value calculator 16.

Some or all of the transmitter/receiver 22, the echo signal processor 23, the echo data acquiring interface 11, and the tracking processor 12 are implemented, for example, by a processing circuitry that includes one or more processors. The memory 13 is, for example, a nonvolatile memory included in the processing circuit.

The radar equipment 201 is arranged on a vessel 1. The target tracking unit 101 tracks the target S of another vessel or the like in the target detection area Ta and displays an echo image indicating the position of the target S on a display device not shown. For example, the target detection area Ta is an area inside a circle of a predetermined size centered on the vessel 1.

The radar unit 20 outputs divided echo data EdD, which is the echo data Ed indicating the correspondence between a position in the divided target area Da and the echo level at the position, based on the reflected wave reflected by the electromagnetic wave transmitted through the antenna 21. The divided target area Da is a sectorial area in which the target detection area Ta is divided into N parts along the azimuthal direction. N is an integer of 2 or more. The echo level at each position of the divided echo data EdD indicates the level of the reflected wave reflected at that position. For example, the radar unit 20 outputs the divided echo data EdD at an output timing following a predetermined generation period Cd.

More specifically, the transmitter/receiver 22 transmits the electromagnetic wave from an antenna 21 and receives the reflected wave reflected by the transmitted electromagnetic wave from the antenna 21 during a sweep period T of a predetermined length. The transmitter/receiver 22 outputs digital data Dd by digitally converting the echo signal indicating the received reflected wave.

The transmitter/receiver 22 periodically repeats the transmission of the electromagnetic wave and the generation of digital data Dd while rotating the antenna 21 so that the azimuth angle in the transmission direction of the electromagnetic wave changes by a predetermined angle every sweep period T. Each time the transmitter/receiver 22 generates digital data Dd, it outputs the generated digital data Dd to the echo signal processor 23.

The echo signal processor 23 outputs divided echo data EdD based on a plurality of digital data Dd received from the transmitter/receiver 22. For example, the echo signal processor 23 generates the divided echo data EdD in which echo levels at a plurality of positions of the division target area Da are binarized. More specifically, the divided echo data EdD is generated in which the value of the echo level at a position where the echo level is equal to or greater than a predetermined threshold Tx among a plurality of positions of the division target area Da is converted to “1” and the value of the echo level at a position where the echo level is less than the threshold Tx is converted to “0”. Each time the echo signal processor 23 generates divided echo data EdD, it transmits the generated divided echo data EdD to the target tracking unit 101.

The echo data acquiring interface 11 in the target tracking unit 101 acquires the concatenated echo data EdC which is the echo data Ed indicating the correspondence between the position in the target detection area Ta and the echo level in the position. For example, echo data acquiring interface 11 generates the concatenated echo data EdC at the generation timing Gs according to the scan period Cs which is N times the generation period Cd. More specifically, the echo data acquiring interface 11 receives the divided echo data EdD from the echo signal processor 23 and stores the received divided echo data EdD in the memory 13. Each time the divided echo data EdD stored in the memory 13 reaches N, the echo data acquiring interface 11 acquires N divided echo data EdD from the memory 13 and concatenates them to generate the concatenated echo data EdC. The echo data acquiring interface 11 stores the generated concatenated echo data EdC in the memory 13.

The tracking processor 12 performs tracking processing to track the target S based on the echo data Ed. More specifically, when the echo data acquiring interface 11 stores the concatenated echo data EdC in the memory 13, the tracking processor 12 specifies coordinates indicating the current position of the target S based on the concatenated echo data EdC. Then, the fluctuation value calculator 16 calculates the predicted speed vector Vc of the target S based on the coordinates indicating the present position of the specified target S, the speed vector inferred from the coordinates of the target S in the past sweep period T and the scan period Cp. The calculated predicted speed vector Vc of the target S is stored in the memory 13.

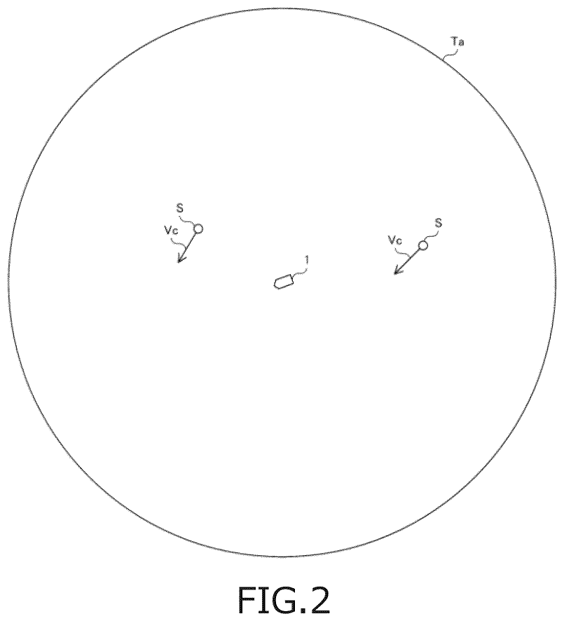

FIG. 2 is a diagram showing an example of an echo image displayed by the tracking processor in the radar equipment according to an embodiment of the disclosure. Referring to FIG. 2, the tracking processor 12 performs processing to display the target S. More specifically, the tracking processor 12 generates an echo image showing the coordinates of the target S detected in the target detection area Ta and the predicted speed vector V1 of the target S and performs processing to display the generated echo image on a display 30.

For example, the tracking processor 12 updates the echo image displayed on the display device whenever echo data acquiring interface 11 stores the linked echo data EdC in the memory 13. More specifically, the tracking processor 12 calculates the predicted position E of the target S at the next generation timing Gs of the linked echo data EdC based on the latest position where the reflector R is detected (hereinafter referred to as “detection position P”) of the target S and the latest velocity vector V1 in the tracking process. Then, the tracking processor 12 determines the selection range Ar of a rectangle centered on the calculated predicted position E. The shape of the selection range Ar is not limited to a rectangle, and may be a polygon other than a rectangle, a circle, an ellipse, or a sector.

When the new connected echo data EdC is stored in the memory13 by the echo data acquiring interface 11, the tracking processor 12 detects the target S in the selection range Ar based on the connected echo data EdC, and specifies coordinates indicating the detection position P of the detected target S. Then, the tracking processor 12 generates an echo image including the detection position P of the target S and the velocity vector V1 of the target S, and updates the echo image displayed on the display device to the generated echo image. The tracking processor12 may generate an echo image including the predicted position E instead of or in addition to the detection position P.

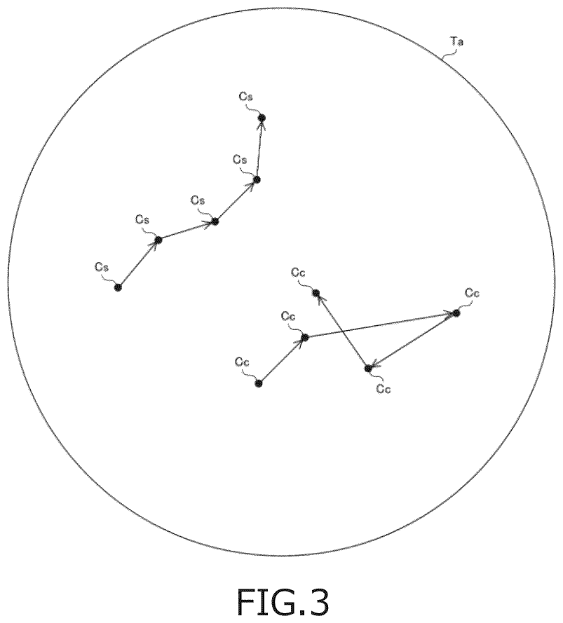

FIG. 3 is a diagram showing a trail of the target to be detected by the radar equipment according to the embodiment of the disclosure and a trail of the clutter generation point. FIG. 3 shows the coordinates Cs of the target S and the coordinates Cc of the clutter generation point C specified by the tracking processor 12 based on the time series of 5 concatenated echo data EdC. For example, the clutter is a sea clutter, and a clutter generation point C is a sea surface.

Referring to FIG. 3, the fluctuation at the clutter generating point C is larger than the fluctuation at the target S. This is because clutter occurs randomly at any position on the sea surface. In the conventional radar equipment, instead of the target S to be tracked, the clutter occurrence point C may be tracked preferentially. Therefore, the target tracking unit 101 according to the embodiment of the disclosure suppresses erroneous tracking of the target S at the target detection area Ta where clutter occurs by the following configuration.

The calculation of the fluctuation value FV is described below. The fluctuation value calculator 16 calculates the fluctuation value FV indicating the fluctuation of the target R whose echo level is equal to or greater than a predetermined threshold based on the plurality of echo data Ed of the time series. For example, when the tracking processor 12 detects the unknown target R based on the concatenated echo data EdC stored in the memory 13 by the echo data acquiring interface 11, the fluctuation value calculator 16 calculates the fluctuation value FV indicating the fluctuation of the detected target R. The index value IN is, for example, a statistical value calculated based on the amount of change in the velocity vector V1 of the reflector R.

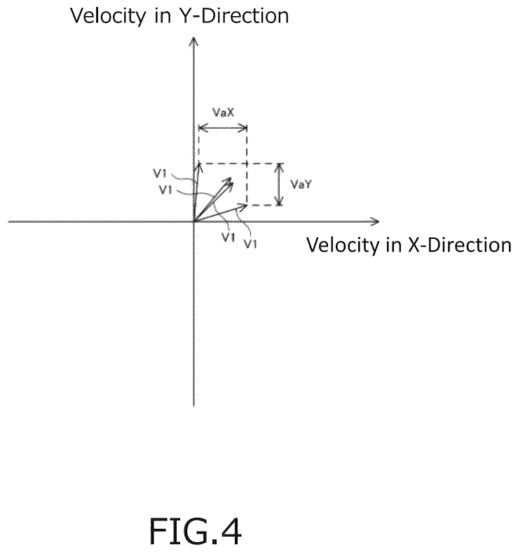

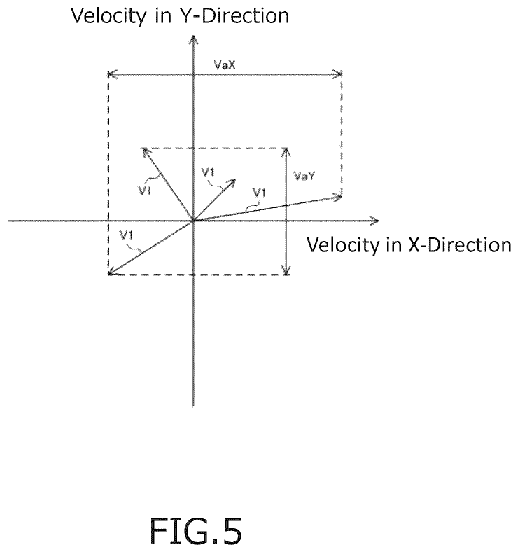

FIGS. 4 and 5 are diagrams showing an example of the method for calculating the fluctuation value by the tracking processor in the radar equipment according to the embodiment of the disclosure. In FIGS. 4 and 5, the horizontal axis indicates the velocity in the X direction, and the vertical axis indicates the velocity in the Y direction. The X direction is, for example, an east-west direction. The Y direction is, for example, a north-south direction. FIG. 4 shows an absolute value Va which is a fluctuation value FV calculated based on the trail of target S shown in FIG. 3. FIG. 5 shows an absolute value Va which is a fluctuation value FV calculated based on the trail of the clutter generating point C shown in FIG. 3.

Referring to FIGS. 4 and 5, the tracking processor 12 calculates absolute values VaX and VaY indicating the amount of fluctuation of the reflector R based on the amount of change of the velocity vector V1 of the reflector R. More specifically, when the reflector R is detected, the tracking processor 12 calculates the velocity vector V1 of the reflector R based on the detected coordinates of the reflector R, the coordinates of the reflector R in the past sweep period T, and the scan period Cs, and stores the calculated velocity vector V1 in the memory 13. The tracking processor 12 acquires four velocity vectors V1 of the reflector R from the storage unit 13, which are calculated based on the time-series 5 connected echo data EdC.

Then, as the fluctuation value FV of the target R, the fluctuation value calculator 16 calculates the absolute value Va of the difference between the maximum value of the calculated four velocity vectors V1 and the minimum value of the four velocity vectors V1. More specifically, as the fluctuation value FV of the target R, the fluctuation value calculator 16 calculates the absolute value VaX, which is the absolute value Va of the difference between the maximum value and the minimum value of the four velocity vectors V1 in the X direction, and the absolute value VaY, which is the absolute value Va of the difference between the maximum value and the minimum value of the four velocity vectors V1 in the Y direction.

The tracking processor 12 may be configured to calculate two, three, or five or more velocity vectors V1 using three, four, or six or more connected echo data EdC, and to calculate absolute values VaX and VaY based on the calculated velocity vectors V1.

Determination of threshold TH—The fluctuation value calculator 16 determines a fluctuation threshold TH based on the size of the target R. For example, when the target extracting module 12 detects an unknown target R based on the concatenated echo data EdC stored in memory 13 by the echo data acquiring interface 11, the fluctuation value calculator 16 calculates the size of the unknown target R and determines the fluctuation threshold TH based on the size of the detected target R.

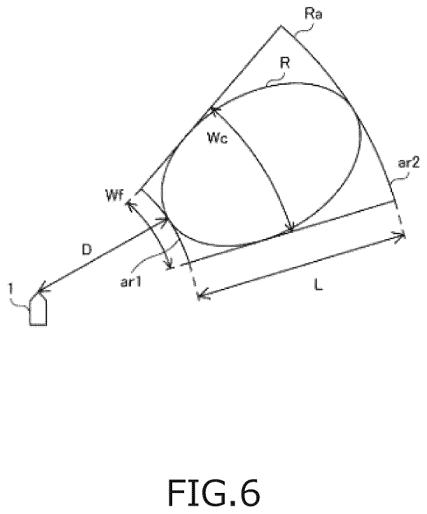

FIG. 6 is a diagram showing an example of a method for determining a threshold by the tracking processor 12 in a radar equipment according to an embodiment of the disclosure.

Referring to FIG. 6, when the tracking processor 12 detects the target R, the target R is approximated by a polygonal reference shape Ra. For example, reference shape Ra is a Baumkuchen-type shape. More specifically, reference shape Ra is a region bounded by two straight lines extending in the distance from the antenna 21 and two arcs ar1, ar2 extending in the azimuthal direction around the antenna 21. That is, the reference shape Ra is a region bounded by two circular arcs ar1, ar2 centered at the antenna 21 and two-line segments connecting the two ends of arc ar1 and the two ends of arc ar2, respectively. The tracking processor 12 approximates a region of the target R whose echo level is equal to or greater than a predetermined threshold by reference shape Ra inscribed with the region of the target R. For example, the reference shape Ra may be a sectorial region.

When the target R is approximated by the reference shape Ra, the fluctuation value calculator 16 calculates the depth length L of the reference shape Ra relative to the antenna 21. The fluctuation value calculator 16 calculates the distance D between the antenna 21 and the target R. The fluctuation value calculator 16 calculates the width W of the reference shape Ra in the azimuthal direction around the antenna 21. More specifically, the fluctuation value calculator 16 calculates the front width Wf, which is the width W corresponding to the length of the arc ar1, and the center width Wc, which is the width W passing through the midpoint of the reference shape Ra in the depth direction.

The tracking processor 12 determines the fluctuation threshold TH based on the magnitude of the reference shape Ra. More specifically, the fluctuation value calculator 16 calculates the fluctuation threshold TH according to the following equation 1:

$$Equation 1$$

$$TH = min ( Wf , \frac{L + Wc}{2} ) + α \qquad ( 1 )$$

Here, a is a fixed value which is set in advance according to the speed and acceleration of the target S to be assumed.

For example, the fluctuation value calculator 16 calculates the size of the target R based on the distance D between the antenna 21 and the target R. More specifically, the smaller the distance D, the larger the size of the region of the target R calculated by the tracking processor 12, regardless of the actual size of the target R. Therefore, the tracking processor 12 corrects the length L, the front-most width Wf, and the center width We by using the coefficient Cf corresponding to the distance D and calculates the fluctuation threshold TH by using the corrected length L, the front-most width Wf, and the center width Wc.

Next, the determination process will be described. The tracking processor 12 judges whether or not the fluctuation value FV is equal to or greater than the fluctuation threshold TH. More specifically, when the fluctuation value calculator 16 calculates the absolute values VaX and VaY, which are the fluctuation values FV of the target R, and the fluctuation threshold TH, it compares the calculated absolute values VaX and VaY with the calculated threshold TH.

For example, when the absolute values VaX and VaY of the target R are both less than the fluctuation threshold TH, the tracking processor 12 tracks the target R as the target S to be tracked. That is, the tracking processor 12 determines that the target R is the target S of the detection target and determines to include the target R as the tracking target. Then, the tracking processor 12 starts tracking the target R.

On the other hand, the tracking processor 12 does not track the target R to be tracked when at least one of the absolute values VaX and VaY of the target R is equal to or greater than the fluctuation threshold TH. That is, the tracking processor 12 determines that the target R is not the target S of the detection target and decides to remove the target R from the tracking target in the tracking processing.

For example, the tracking processor 12 removes the target R from the tracking target in the tracking processing based on the linked echo data EdC and other linked echo data EdC generated after the linked echo data EdC when one of the absolute values VaX and VaY of the target R detected based on the linked echo data EdC is equal to or greater than the fluctuation threshold TH.

More specifically, when at least one of the absolute values VaX and VaY of the reflector R is equal to or greater than the threshold value TH in the connected echo data EdC generated first after the activation of the target tracking unit 101, the tracking processor 12 maintains a state in which the reflector R is removed from the tracking target even when the absolute values VaX and VaY of the reflector R in the other connected echo data EdC generated after the connected echo data EdC have shifted to less than the threshold value TH.

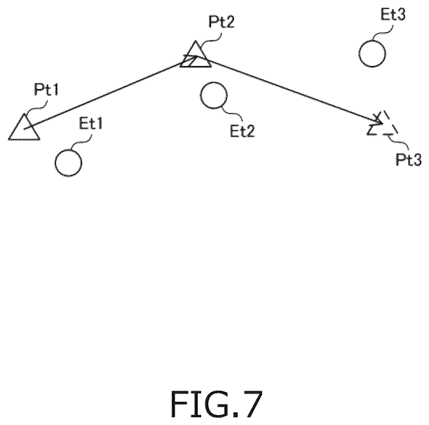

FIG. 7 is a diagram showing an example of a detected position and a predicted position of the reflector R detected at each timing of a predetermined period.

Triangles in FIG. 7 indicate detection positions Pt1, Pt2, and Pt3 that are detection positions P of the reflector R at times t1, t2, and t3, respectively. Circles in FIG. 7 indicate prediction positions Et1, Et2, and Et3 that are prediction positions E of the reflector R at times t1, t2, and t3, respectively. Times t1, t2, and t3 are generation timings Gs of three connected echo data EdC in time series. In FIG. 7, for explanation, prediction positions Et not included in the echo image are shown in addition to detection positions Pt included in the echo image.

Referring to FIG. 7, when the absolute values VaX and VaY of the reflector R detected based on the connected echo data EdC generated at times t1 and t2 are less than the threshold value TH, the tracking processor 12 tracks the reflector R as the target S. Then, the tracking processor 12 generates an echo image including a triangle icon indicating the detection positions Pt1 and Pt2 of the reflector R at times t1 and t2.

Thereafter, when at least one of the absolute values VaX and VaY of the reflector R detected based on the connected echo data EdC generated at time t3 is equal to or greater than the threshold value TH, the tracking processor 12 determines that the reflector R is not the target S to be tracked, and decides to exclude the reflector R from the tracking target in the tracking processing after time t3. The tracking processor 12 does not generate an echo image indicating the detection position Pt3 of the reflector R after time t3.

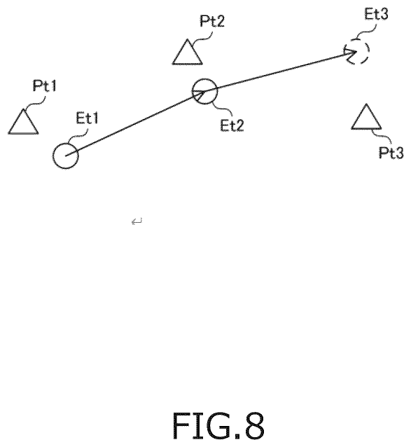

FIG. 8 is a diagram showing an example of an echo image generated by the tracking processor in the radar apparatus according to the embodiment of the present invention. As described above, the tracking processor 12 may generate an echo image including the predicted position E instead of or in addition to the observed position P. In this case, the tracking processor 12 generates the echo image shown in FIG. 8.

In this embodiment, the tracking processor 12 maintains the target R from the tracking target even if the absolute values VaX and VaY of the target R are less than the fluctuation threshold TH in other linked echo data EdC generated after the linked echo data EdC, for example, when one of the absolute values VaX and VaY of the target R in the linked echo data EdC generated first after the activation of the target tracking unit 101 is equal to or greater than the fluctuation threshold TH.

For example, the tracking processor 12 further performs background tracking processing to track the target R removed from the tracking target in the tracking processing. While the tracking processor 12 performs processing to display the target S as described above, it does not perform processing to display the tracking result of the tracked target R in the background tracking processing. That is, the tracking processor 12 generates an echo image that indicates the position of the target S and does not contain information such as the position of the target R and performs processing to display the generated echo image on a display device not shown.

In addition to the target S, the tracking processor 12 may be configured to perform processing to display the target R tracked in the background tracking processing. In this case, for example, the tracking processor 12 performs a process of displaying the target S tracked in the tracking process and the target R tracked in the background tracking processing different ways from each other. Specifically, the tracking processor 12 performs a process of displaying the icon indicating the target S and the icon indicating the target R in different colors or different figures from each other.

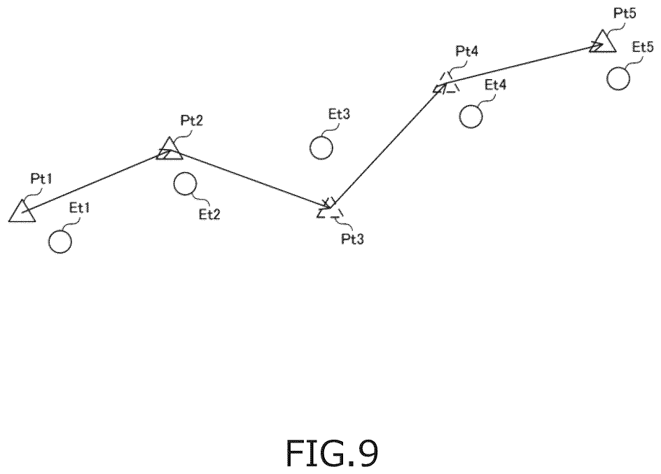

FIG. 9 is a diagram showing another example of an echo image generated by the tracking processor in the radar apparatus according to the embodiment of the present invention. Triangles with solid lines in FIG. 9 indicate detection positions Pt1, Pt2, and Pt5, which are detection positions P of the reflector R at times t1, t2, and t5, respectively. Triangles with broken lines in FIG. 9 indicate detection positions Pt3, Pt4, which are detection positions P of the reflector R at times t3, t4, respectively. Circles in FIG. 9 indicate predicted positions Et1, Et2, Et3, Et4, and Et5, which are predicted positions E of the reflector R at times t1, t2, t3, t4, and t5, respectively. Times t1, t2, t3, t4, and t5 are generation timings Gs of the five concatenated echo data EdC in the time series. FIG. 9 shows predicted positions Et not included in the echo image in addition to detection positions Pt included in the echo image for explanation.

Referring to FIG. 9, when at least one of the absolute values VaX and VaY of the reflector R detected on the basis of the connected echo data EdC generated at time t3 is equal to or greater than the threshold TH, and when at least one of the absolute values VaX and VaY of the reflector R detected on the basis of the connected echo data EdC generated at time t4 is equal to or greater than the threshold TH, the tracking processor 12 determines that the reflector R is not the target S to be tracked, and performs background tracking processing at time t3 and t4. Then, the tracking processor 12 generates an echo image including a dashed triangular icon indicating the detection positions Pt3 and Pt4 of the reflector R at time t3 and t4.

Thereafter, when the absolute values VaX and VaY of the reflector R detected on the basis of the connected echo data EdC generated at time t5 are less than the threshold value TH, the tracking processor 12 terminates the background tracking processing and restarts the tracking processing for tracking the reflector R as the target S. Then, the tracking processor 12 generates an echo image including a solid triangle icon indicating the detection position Pt5 of the reflector R at time t5.

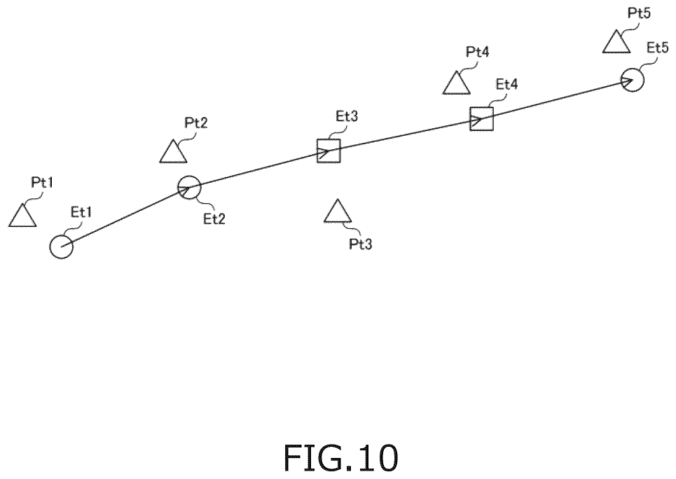

FIG. 10 is a diagram showing another example of an echo image generated by the tracking processor in the radar apparatus according to the embodiment of the present invention. Triangles of solid lines in FIG. 10 indicate detection positions Pt1, Pt2, Pt3, Pt4, and Pt5, respectively. Circles in FIG. 10 indicate predicted positions Et1, Et2, and Et5, respectively. Rectangles in FIG. 10 indicate predicted positions Et3, Et4, respectively.

Referring to FIG. 10, when at least one of the absolute values VaX and VaY of the reflector R detected on the basis of the connected echo data EdC generated at time t3 is equal to or greater than the threshold TH, and when at least one of the absolute values VaX and VaY of the reflector R detected on the basis of the connected echo data EdC generated at time t4 is equal to or greater than the threshold TH, the tracking processor 12 determines that the reflector R is not the target S to be tracked, and performs interpolation processing for interpolating the position of the target S at time t3 and t4 with the predicted positions Et3 and Et4. Then, the tracking processor 12 generates an echo image including a square icon indicating the position of the target S interpolated in the interpolation processing.

Thereafter, when the absolute values VaX and VaY of the reflector R detected based on the connected echo data EdC generated at time t5 are less than the threshold value TH, the tracking processor 12 terminates the interpolation processing and restarts the tracking processing for tracking the reflector R as the target S. Then, the tracking processor 12 generates an echo image including a solid triangle icon indicating the detection position Pt5 of the reflector R at time t5.

As described above, the tracking processor 12 may generate an echo image including the predicted position E instead of or in addition to the detection position P. In this case, the tracking processor 12 generates the echo image shown in FIG. 10. That is, when the background tracking process is performed at times t3 and t4, the tracking processor 12 generates an echo image including a square icon indicating the predicted position Et3 and Et4 of the reflector R at times t3 and t4. Then, when the background tracking process is terminated at time t5, the tracking processor 12 generates an echo image including, for example, a solid circle icon indicating the predicted position Et5 of the reflector R at time t5.

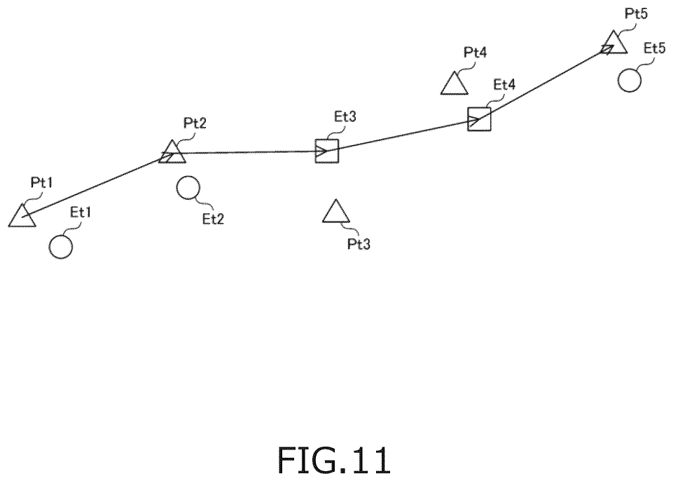

FIG. 11 is a diagram showing another example of an echo image generated by the tracking processor in the radar apparatus according to the embodiment of the present invention. Triangles of solid lines in FIG. 11 indicate detection positions Pt1, Pt2, Pt3, Pt4, and Pt5, respectively. Circles in FIG. 11 indicate predicted positions Et1, Et2, and Et5, respectively. Rectangles in FIG. 11 indicate predicted positions Et3, Et4, respectively.

Referring to FIG. 11, when at least one of the absolute values VaX and VaY of the reflector R detected on the basis of the concatenated echo data EdC generated at time t3 is equal to or greater than the threshold TH, and when at least one of the absolute values VaX and VaY of the reflector R detected on the basis of the concatenated echo data EdC generated at time t4 is equal to or greater than the threshold TH, the tracking processor 12 determines that the reflector R is not the target S to be tracked, and removes the reflector R detected on the basis of the concatenated echo data EdC from the target to be tracked in the tracking process. Then, the tracking processor 12 performs interpolation processing for interpolating the position of the target S at time t3 and t4 with the predicted positions Et3 and Et4. Then, the tracking processor 12 generates an echo image including a square icon indicating the position of the target S interpolated in the interpolation processing.

Thereafter, when the absolute values VaX and VaY of the reflector R detected based on the connected echo data EdC generated at time t5 are less than the threshold value TH, the tracking processor 12 terminates the interpolation processing and restarts the tracking processing for tracking the reflector R as the target S. Then, the tracking processor 12 generates an echo image including a solid triangle icon indicating the detection position Pt5 of the reflector R at time t5.

As described above, the tracking processor 12 may generate an echo image including the predicted position E instead of or in addition to the detection position P. In this case, the tracking processor 12 generates the echo image shown in FIG. 10. That is, when the interpolation processing is performed at times t3 and t4, the tracking processor 12 generates an echo image including a square icon indicating the predicted position Et3 and Et4 of the reflector R at times t3 and t4. Then, when the interpolation processing is terminated at time t5, the tracking processor 12 generates an echo image including, for example, a solid circle icon indicating the predicted position Et5 of the reflector R at time t5.

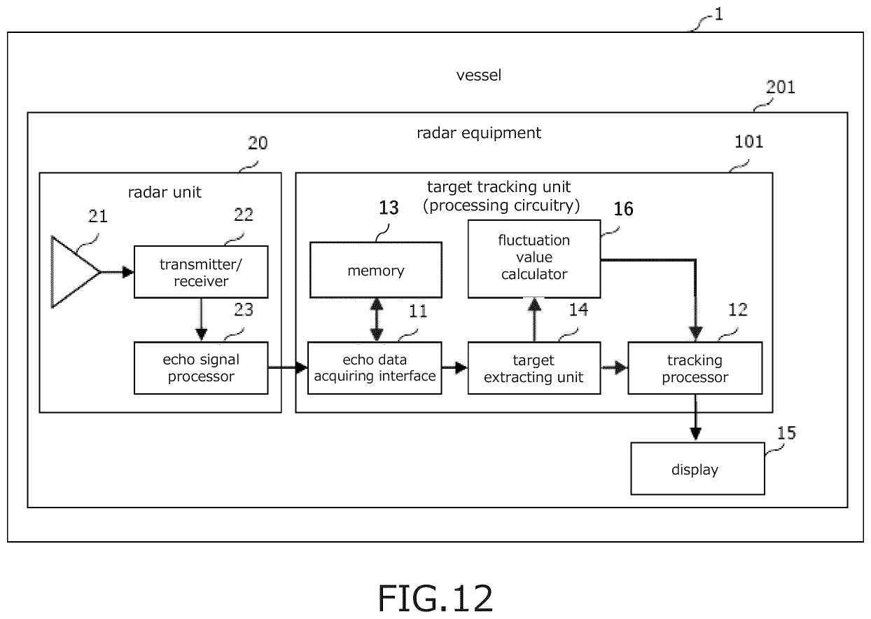

FIG. 12 is a diagram showing another configuration of a radar equipment according to an embodiment of the disclosure.

The configuration shown in FIG. 12 differs from the configuration shown in FIG. 1 in that the result of the index value indicating the fluctuation of the reflector R obtained by the fluctuation value calculator 15 is output to the tracking processor 12. The other configurations are basically the same.

The tracking processor 12 receives the index value indicating the fluctuation of the reflector R and determines the display of the reflector R detected at each timing on the display 15 based on the value. The method of determining the display has already been described and will be omitted here.

The radar equipment according to an embodiment of the disclosure includes a computer including a memory, and a processor such as a CPU in the computer reads a program including a part or all of the steps of the following flowchart from the memory and executes the program. The program of the equipment can be installed externally. The program of the equipment is distributed in the state stored in the recording medium or through the communication line. Since it is obvious that the modified configuration described in the embodiment shown in FIG. 1 may also be adopted in the embodiment shown in FIG. 12, the detailed description thereof is omitted.

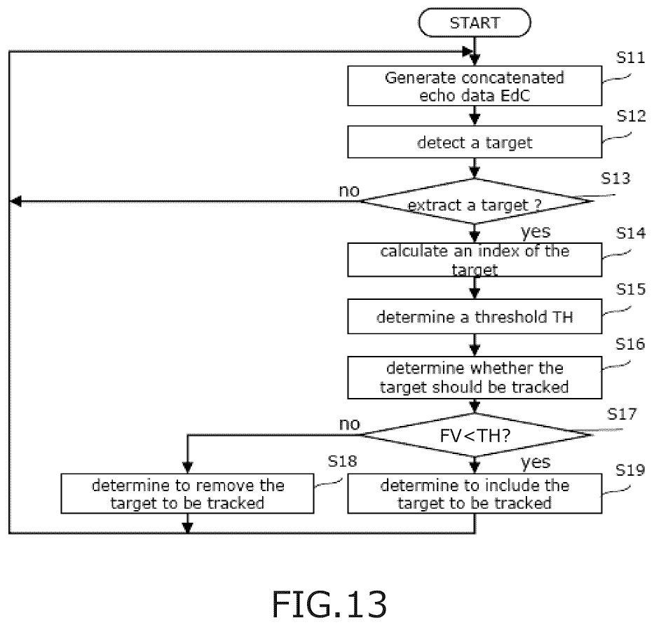

FIG. 13 is a flowchart showing an example of the operation when the target tracking processor in the radar equipment according to the embodiment of the disclosure performs tracking processing.

Referring to FIG. 13, at first, the target tracking unit 101 generates the concatenated echo data EdC by concatenating the N divided echo data EdD received from the radar unit 20 step S11.

Next, the target tracking unit 101 performs a process of tracking the target S and displaying the target S based on the concatenated echo data EdC generated. More specifically, the target tracking unit 101 generates an echo image showing the coordinates of the target S and the predicted speed vector V1 of the target S, and performs a process of displaying the generated echo image on a display device not shown step S12.

Next, the target tracking unit 101 repeats the processes of steps S11 and S12 until the unknown target R is detected NO in step S13 based on the generated concatenated echo data EdC.

Next, when the unknown target R is detected based on the generated concatenated echo data EdC YES in step S13, the fluctuation value calculator 16 of the target tracking unit 101 calculates the fluctuation value FV of the target R using the 5 concatenated echo data EdC of the time series. More specifically, the target tracking unit 101 calculates the absolute values VaX and VaY of the target R as the fluctuation value FV of the target R step S14.

The target tracking unit 101 then determines the fluctuation threshold TH based on the size of the target R. More specifically, The target tracking unit 101 approximates the target R by a polygonal reference shape Ra, and calculates the fluctuation threshold TH based on the size of the reference shape Ra according to equation 1 described above step S15.

Next, the target tracking unit 101 performs determination processing to determine whether the fluctuation value FV of the target R is equal to or greater than the fluctuation threshold TH step S16.

Next, if at least one of the absolute values VaX and VaY, which are the fluctuation values FV of the target R, is equal to or greater than the fluctuation threshold TH NO in step S 17, the target tracking unit 101 determines to remove the target R from the tracking target step S18.

Next, the target tracking unit 101 repeats the processing in steps S11 and S12 until it detects a new unknown target R NO in step S13.

On the other hand, if the absolute values VaX and VaY of the target R are both less than the fluctuation threshold TH YES in step S17, the target tracking unit 101 determines that the target R is the target S to be tracked of the detection target and decides to include the target R as the tracking target step S19.

Next, the target tracking unit 101 repeats the processing of step S11 and step S12 until a new unknown target R is detected NO in step S13.

When the target tracking unit 101 determines to remove the target R from the tracking target in step S18, the target tracking processor may start the background tracking processing to track the target R. In this case, for example, the target tracking unit 101 performs the processing to display the target S in the processing in step S12. However, it does not perform the processing to display the tracking result of the tracked target R in the background tracking processing. That is, while the target tracking unit 101 tracks the target R in the background tracking processing, it generates an echo image containing no information such as the position of the target R and performs the processing to display the generated echo image on a display device not shown.

In the target tracking unit 101 according to the embodiment of the disclosure, the tracking processor 12 is configured to calculate the absolute values VaX and VaY as the fluctuation values FV of the target R but is not limited to this. The tracking processor 12 may be configured to calculate other statistical values for the plurality of velocity vectors V1 of the target R instead of or in addition to the absolute values VaX and VaY. The statistical values may be mean, median, or standard deviation.

In the target tracking unit 101 according to the embodiment of the disclosure, the tracking processor 12 is configured to calculate the fluctuation threshold TH according to the equation 1, but this is not limited to the above. The tracking processor 12 may be configured to further determine the fluctuation threshold TH based on the size of the target R and AIS information received from another ship. In this case, the tracking processor 12 further determines the fluctuation threshold TH based on the size of the other ship around the vessel 1 indicated by the AIS information.

In addition, the fluctuation value calculator 16 may be configured to calculate the fluctuation threshold TH according to other mathematical expressions instead of the equation 1. For example, the fluctuation value calculator 16 may calculate the fluctuation threshold TH according to the following equation 2 because the azimuthal fluctuation of the target S dominates and the component of the fluctuation in the distance direction can be ignored when tracking the point closest to the antenna 21 in the target S in the tracking processing.

$$Equation 2$$

$$TH = min ( Wf , Wc \times k ) + α \qquad ( 2 )$$

where k is a constant. For example, k is greater than zero and less than or equal to one.

On the other hand, since the tracking processor 12 cannot ignore the component of the fluctuation in the distance direction, when tracking the center point in the target S in the tracking processing, it calculates the fluctuation threshold TH according to the above formula 1.

Other examples of index value IN are described below.

Although the tracking processor 12 is configured to calculate the absolute values VaX and VaY as the index value IN indicating the fluctuation of the reflector R, the present invention is not limited thereto. The tracking processor 12 may be configured to calculate another statistical value based on the amount of change of a plurality of velocity vectors V1 as the index value IN. The statistical value may be an average value, a median value, or a standard deviation.

For example, the tracking processor 12 extracts a plurality of X-direction components Ix and a plurality of Y-direction components Iy from the plurality of velocity vectors V1. The tracking processor 12 may calculate the variance of the plurality of X-direction components Ix, the standard deviation of the plurality of X-direction components Ix, the average deviation of the plurality of X-direction components Ix, the interquartile range of the plurality of X-direction components Ix, or the interquartile deviation of the plurality of X-direction components Ix as the index value IN, instead of the absolute value VaX.

The tracking processor 12 may calculate, as the index value IN, the variance of the plurality of Y-direction components Iy, the standard deviation of the plurality of Y-direction components Iy, the average deviation of the plurality of Y-direction components Iy, the quartile range of the plurality of Y-direction components Iy, or the quartile deviation of the plurality of Y-direction components Iy. The tracking processor 12 may calculate, as the index value IN, the statistical value of the angle formed by the plurality of velocity vectors V1 instead of the absolute values VaX and VaY, or the statistical value of the cosine distance of the plurality of velocity vectors V1. The tracking processor 12 may calculate, as the index value IN, a value obtained by combining the above plurality of statistical values.

The index value IN is a statistical value calculated based on the amount of change in the velocity vector V1 of the reflector R, but the index value IN is not limited thereto. The index value IN may be a statistical value calculated based on the amount of change in the velocity of the reflector R. More specifically, the tracking processor 12 calculates a plurality of scalar velocities Sv corresponding to the plurality of velocity vectors V1. The scalar velocity Sv is a scalar quantity of the velocity of the reflector R.

As the index value IN, the tracking processor 12 may calculate the absolute value of the difference between the maximum value and the minimum value of the plurality of scalar velocities Sv calculated, may calculate the variance of the plurality of scalar velocities Sv, may calculate the standard deviation of the plurality of scalar velocities Sv, may calculate the average deviation of the plurality of scalar velocities Sv, may calculate the quartile range of the plurality of scalar velocities Sv, and may calculate the quartile deviation of the plurality of scalar velocities Sv.

The index value IN may be a statistical value calculated based on the amount of change in the position of the reflector R. More specifically, the tracking processor 12 calculates the amount of position change Vp of the position of the reflector R for each scan period Cs using a plurality of detection positions closest to the reflector R. The amount of position change Vp is a scalar quantity of the moving distance of the reflector R.

The tracking processor 12 may calculate, as the index value IN, the absolute value of the difference between the maximum value and the minimum value of the plurality of calculated position change amounts Vp. The calculation method of the tracking processor 12 may be based on the calculation of the variance of the plurality of position change amounts Vp, the standard deviation of the plurality of position change amounts Vp, the average deviation of the plurality of position change amounts Vp, the interquartile range of the plurality of position change amounts Vp, and the interquartile deviation of the plurality of position change amounts Vp.

Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey those certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be considered that the above embodiment is exemplary in all respects and not restrictive. It is intended that the scope of the disclosure be indicated by the claims rather than the above description and include all changes within the meaning and scope of the claims and equivalence.

### LIST OF REFERENCE NUMERALS

1 vessel
11 echo data acquiring interface
12 tracking processor
13 memory
14 target extracting unit
15 display
16 fluctuation value calculator
20 radar unit
21 antenna
22 transmitter/receiver
23 echo signal processor
30 display
101 target tracking unit
201 radar equipment
Ta target detection area
S target
Vc predicted speed vector
Cs, Cc coordinate
V1 speed vector
VaX, VaY absolute value
R target
Ra reference shape
Wf front width
We center width
L length
D distance
ar1, ar2 arc

What is claimed is:

1. A target tracking apparatus for tracking a target on the water, comprising:
processing circuitry configured to:
periodically acquire echo data indicating a correspondence relationship between a position in the detection area and the level of the reflected wave at which the electromagnetic wave transmitted through an antenna is reflected at the position;
extract one or a plurality of potential targets to be tracked based on the level of the echo data;
calculate each fluctuation value of the potential target based on the acquired echo data of the potential target at each timing acquired the echo data;
determine a target to be tracked based on the fluctuation value; and
track the target.

2. The target tracking apparatus of claim 1, wherein:
the processing circuitry is configured to calculate the fluctuation value based on the change in the velocity vector of the potential target calculated based on the position of the potential target acquired at each successive timing.

3. The target tracking apparatus of claim 1, wherein:
the processing circuitry is configured to calculate the fluctuation value based on the area of the region formed by the end points when the velocity vectors share a common base point.

4. The target tracking apparatus of claim 1, wherein:
the processing circuitry is configured to select the potential target as a target to be tracked, whose fluctuation value is less than a fluctuation threshold.

5. The target tracking apparatus of claim 1, wherein:
the processing circuitry is configured to select the potential target having the smallest fluctuation value as a target to be tracked.

6. The target tracking apparatus of claim 1, wherein:
the processing circuitry is configured to:
determine a fluctuation threshold based on the size of the potential target; and
determine whether the fluctuation value is less than the fluctuation threshold or not, wherein
when the fluctuation value is less than the fluctuation threshold, the processing circuitry is configured to select the potential target as a target to be tracked.

7. The target tracking apparatus of claim 6, wherein:
when the fluctuation value is equal to or greater than the fluctuation threshold, the processing circuitry is configured to track the predicted position based on the position of the target already tracked as the target to be tracked.

8. The target tracking apparatus of claim 7, further comprising:
a display configured to display the target tracked.

9. The target tracking apparatus of claim 8, wherein:
when the fluctuation value is equal to or greater than the fluctuation threshold, the processing circuitry is configured to track the target by the background tracking process.

10. The target tracking apparatus of claim 8, wherein:
the display is configured to skip to display the target by the background tracking process.

11. The target tracking apparatus of claim 8, wherein:
the display is configured to display the target by the background tracking process in a manner different from the tracked target by the tracking process.

12. The target tracking apparatus of claim 1, wherein:
the processing circuitry is further configured to remove the target tracked based on a first target echo data and the target echo data acquired after the first echo data, when the fluctuation value of the target extracted based on the first target echo data is equal to or greater than the fluctuation threshold.

13. The target tracking apparatus of claim 12, wherein:
the processing circuitry is configured to interpolate the position of the target with the prediction position of the target when the reflector is removed from the target to be tracked in the tracking process.

14. The target tracking apparatus of claim 1, wherein:
the processing circuitry is configured to:
approximate the target by a polygonal reference shape; and
determine the fluctuation threshold based on the size of the polygonal reference shape.

15. The target tracking apparatus of claim 1, wherein:
the processing circuitry is configured to:
approximate the target by a reference shape surrounded by two lines extending in the distance direction from the antenna and two arcs extending in the azimuthal direction around the antenna; and
determine the fluctuation threshold based on the size of the reference shape.

16. The target tracking apparatus of claim 1, wherein:
the processing circuitry is configured to calculate the size of the target based on the distance between the antenna and the target.

17. The target tracking apparatus of claim 1, wherein:
the processing circuitry is further configured to determine the fluctuation threshold based on Automatic Identification System AIS information transmitted from another vessel.

18. The target tracking apparatus of claim 1, further comprising:
a memory including a computer code configured to, when executed by the processing circuitry, cause the apparatus to:
periodically acquire echo data indicating a correspondence relationship between a position in the detection area and the level of the reflected wave at which the electromagnetic wave transmitted through an antenna is reflected at the position;
extract one or a plurality of potential targets to be tracked based on the level of the echo data;
calculate each fluctuation value of the potential target based on the acquired echo data of the potential target at each timing acquired the echo data;
determined a target to be tracked based on the fluctuation value; and
track the target.

19. A target tracking method for tracking target on the water, comprising:
periodically acquiring echo data indicating a correspondence relationship between a position in the detection area and the level of the reflected wave at which the electromagnetic wave transmitted through an antenna is reflected at the position;
extracting one or a plurality of potential targets to be tracked based on the level of the echo data;
calculating each fluctuation value of the potential target, based on the change in the velocity vector of the potential target calculated based on the position of the potential target acquired at each successive timing;
determining a target to be tracked based on the fluctuation value; and
tracking the target.

20. A non-transitory computer readable medium storing a program causing a computer to execute image process, the image process comprising:
periodically acquiring echo data indicating a correspondence relationship between a position in the detection area and the level of the reflected wave at which the electromagnetic wave transmitted through an antenna is reflected at the position;
extracting one or a plurality of potential targets to be tracked based on the level of the echo data;
calculating each fluctuation value of the potential target based on the acquired echo data of the potential target acquired at each timing;
determining a target to be tracked based on the fluctuation value; and
tracking the target.
